(19) United States
(12) Patent Application Publication
(10) Pub. No.: US 2010/0193298 A1
(43) Pub. Date: Aug. 5, 2010

(54) SELF-AMPLIFYING ELECTROMECHANICAL FRICTION BRAKE

(75) Inventors: Chi-Thuan Cao, Korntal-Muenchingen (DE); Dirk Hofmann, Stuttgart (DE); Herbert Vollert, Vaihingen/Enz (DE); Willi Nagel, Remseck/Hochdorf (DE); Bertram Foitzik, Ilsfeld (DE); Bernd Goetzelmann, Sindelfingen (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Stuttgart (DE)

(21) Appl. No.: 12/438,688

(22) PCT Filed: Jul. 10, 2007
(86) PCT No.: PCT/EP2007/057029

§ 371 Date: Sep. 24, 2009

(30) Foreign Application Priority Data
Aug. 25, 2006 (DE) 10 2006 039 984.6

(51) Int. Cl. F16D 55/224; F16D 55/225; F16D 65/21

(52) U.S. Cl. 188/72.2

(57) ABSTRACT

The invention relates to a self-amplifying electromechanical disc brake, having a friction brake lining, which is able to move on a helical path and having a rack-and-pinion mechanism for moving the friction brake lining and for actuating the disc brake. According to the invention, a rack of the rack-and-pinion mechanism is connected to the friction brake lining in articulating fashion and in the region of a pinion, an abutting support keeps the rack engaged with the pinion, with play, thus permitting the rack to pivot in order to compensate for the helical movement of the friction brake lining.

### PRIOR ART

The invention relates to a self-amplifying electromechanical friction brake with the defining characteristics of the preamble to claim 1.

A friction brake of this kind is known from the patent application DE 103 49 078 A1. The known friction brake is a disc brake and its braking body to be braked is a brake disc. The invention is particularly intended for a disc brake, but it can also be used for other brake designs. The known friction brake has a friction brake lining, which, in order to achieve a self-amplification, is movably guided at angle to a friction surface of the braking body, i.e. at an angle to the brake disc in a disc brake. The term “friction surface” refers to the surface of the braking body that comes into contact with the friction brake lining when the brake is actuated and the braking body is rotating. The rotating brake body exerts a friction force, which is oriented in the circumference direction of the braking body, on the friction brake lining that is pressed against it during braking. The guidance of the friction brake lining at an angle to the friction surface of the braking body produces a reaction force perpendicular to the movement direction. This reaction force has a force component oriented perpendicular to the friction surface of the braking body. This force component is a compressive force that presses the friction brake lining against the braking body in addition to a compressive force exerted by an actuating device, thus increasing the braking force of the friction brake. The guidance of the friction brake lining at an angle to the friction surface of the braking body converts the friction force that the braking body exerts on the friction brake lining, which is pressed against it when the friction brake is actuated, into the above-described compressive force acting in addition to the compressive force exerted by the actuating device and thus increases the braking force of the friction brake, i.e. produces a self-amplification of the friction brake.

In the known friction brake, the friction brake lining is guided by means of ramps that have a slope in relation to the friction surface of the braking body, oriented in its circumference direction. The slope of the ramps can change over a movement path of the friction brake lining in order, for example, to achieve a large advancing distance and a high advancing speed at the beginning of the actuation of the friction brake and to achieve a powerful self-amplification at the end of the movement path, i.e. with a high compressive and braking force. If the ramps have a constant slope over the movement path of the friction brake lining, then they are also referred to as wedges and a wedge mechanism.

The guidance of the friction brake lining in the circumference direction in relation to the braking body and simultaneously at an angle in relation to the friction surface, i.e. with a slope in relation to the braking body, means a mobility of the friction brake lining on a helical path coaxial to a rotation axis of the braking body. In order to achieve the self-amplifying action, the friction brake lining can also be movably guided, for example, in a chord direction in relation to the brake disc, i.e. on a straight path at an angle to the friction surface of the braking body. In order to convert the [missing word], which the rotating braking body exerts on the friction brake lining pressed against it for the braking, into a compressive force, it is essential for the movement direction of the friction brake lining to have a component oriented in the circumference direction of the braking body.

The known friction brake has an electromechanical actuating device for moving the friction brake lining in order to actuate the friction brake. The electromechanical actuating device has an electric motor, a reduction gear that is not absolutely required, and a rack-and-pinion mechanism for converting the rotating driving motion of the electric motor into a translational motion for moving the friction brake lining. A rack of the rack-and-pinion mechanism is rigidly connected to a back side of the friction brake lining oriented away from the braking body. The rack extends in accordance with the movement direction of the friction brake lining on a helical path around the rotation axis of the braking body; the rack has the same slope (not absolutely the same angle) as the movement direction of the friction brake lining. For braking, the electromechanical actuating device moves the friction brake lining, oriented at the angle, in its movement direction toward the friction surface of the braking body so that it comes into contact with the friction surface of the braking body and is pressed against the braking body, thus braking the braking body.

### DISCLOSURE OF THE INVENTION

The friction brake according to the invention, with the defining characteristics of claim 1, has a rack-and-pinion mechanism whose rack is connected to the friction brake lining in articulating fashion. This permits the rack to be a conventional straight rack. In order to guide the rack in the region of a pinion of the rack-and-pinion mechanism and in order to keep the rack engaged with the pinion, the rack-and-pinion mechanism of the friction brake according to the invention has an abutting support that is situated space radially apart from the pinion of the rack-and-pinion mechanism. The rack is situated in an intermediate space between the abutting support and the pinion. The abutting support can be a slide bearing on which the rack slides. In particular, the abutting support is equipped with a roller bearing, for example a roller supported in rotating fashion on which the rack rolls. The abutting support is stationary in relation to the pinion. There is play in the gearing of the rack-and-pinion mechanism of the friction brake according to the invention so that the rack is able to pivot around an imaginary rotation axis of the pinion and/or around an imaginary axis that extends radial to the rotation axis of the pinion, perpendicular to the rack, and passes through a longitudinal center of the rack. The latter axis can also be referred to as the normal axis of the rack. The expression “able to pivot around the rotation axis of the pinion” is equivalent to the expression “able to pivot around an axis parallel to the rotation axis of the pinion.”

In a simple way, the invention permits the rack to adapt to the helical movement of the friction brake lining. The necessary pivoting movements of the rack are slight, which allows them to be compensated for by means of play in the gearing of the rack-and-pinion mechanism. The invention also compensates for misalignments and angle errors between the rack and the movement direction of the friction brake lining. Another advantage of the invention is its compact, comparatively simple construction. The invention requires only an articulating connection; a rugged single-axis hinge is sufficient and a ball joint is not required. In addition, a conventional, straight rack is sufficient for the invention. The guidance of the rack with the abutting support is likewise simple in design.

Advantageous embodiments and modifications of the invention disclosed in claim 1 are the subject of the dependent claims.

### BRIEF DESCRIPTION OF THE DRAWINGS

The invention will be explained in greater detail below in conjunction with an exemplary embodiment shown in the drawings.

FIG. 1 shows a friction brake according to the invention, with a brake disc viewed in the radial direction from the outside;

FIG. 2 shows a section along line II-II in FIG. 1; and

FIG. 3 is a view of a rack-and-pinion mechanism according to arrow III in FIG. 1.

The drawings should be understood to be very schematic, partially simplified representations that are provided for the sake of comprehension and intended for illustration of the invention.

### EMBODIMENT OF THE INVENTION

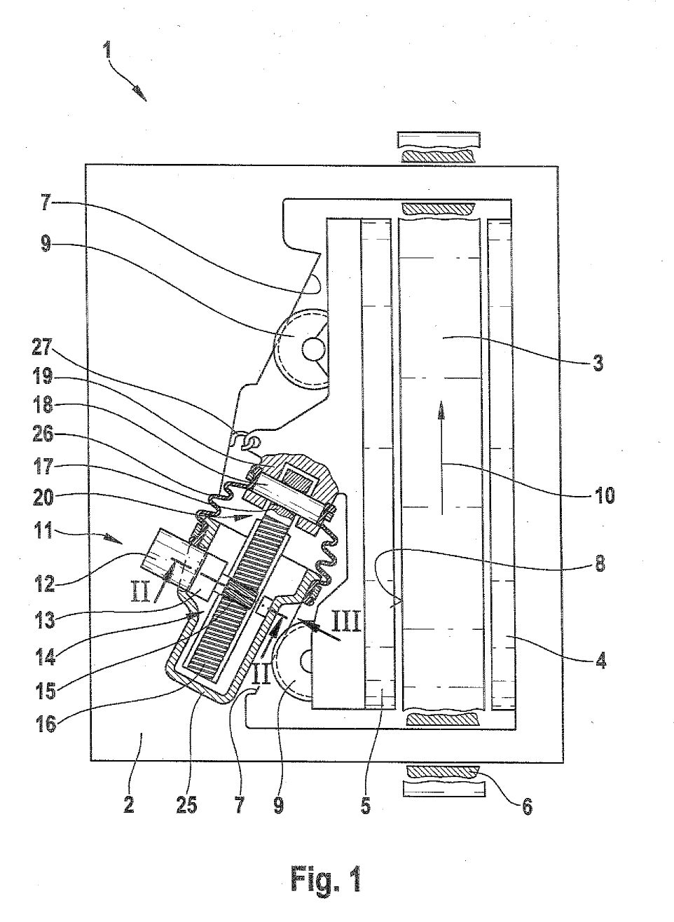

The friction brake according to the invention shown in FIG. 1 is embodied in the form of a disc brake 1 with a brake caliper 2 in which friction brake linings 4, 5 are situated on both sides of a brake disc 3. The friction brake lining 4 on the right in FIG. 1 is situated in stationary fashion in the brake caliper 2 and is therefore referred to below as the fixed friction brake lining 4. The friction brake lining 5 to the left of the brake disc 3 in FIG. 1 can be pressed against the brake disc 3 in order to actuate the disc brake 1, i.e. it is movable in the brake caliper 2. The brake caliper 2 is embodied in the form of a so-called floating caliper, i.e. it is able to move in the indicated guides 6 perpendicular to the brake disc 3. When the movable friction brake lining 5 is pressed against the one side of the brake disc 3, the brake caliper 2 is shifted perpendicular to the brake disc 3 in an intrinsically known fashion and presses the fixed friction brake lining 4 against the other side of the brake disc 3, which is therefore braked.

The brake caliper 2 has ramps 7 that extend in the circumference direction of the brake disc 3 and at an angle, i.e. with a slope, in relation to a friction surface 8 of the brake disc 3. The friction surface 8 is the washer-shaped surface of the brake disc 3 oriented toward the movable friction brake lining 5, against which the friction brake lining 5 rests when the disc brake 1 is actuated and the brake disc 3 is rotating. On the opposite side, the brake disc 3 also has such a friction surface, which is oriented toward the fixed friction brake lining 4. The ramps 7 extend on an imaginary helical path around an imaginary rotation axis of the brake disc 3. The movable friction brake lining 5 is supported with rollers 9 against the ramps 7 and by means of the rollers 9, is guided on the ramps 7 so that it is able to move on an imaginary helical path around the rotation axis of the brake disc 3. The rollers 9 are supported in rotating fashion on a back side of the movable friction brake lining 5 oriented away from the brake disc 3. A maximum movement path of the friction brake lining 5 is relatively short compared to a complete rotation; the friction brake lining 5 is only moved by a fraction of a complete rotation. In the embodiment of the invention shown, the slope of the ramps 7 is constant, i.e. they can also be referred to as wedges or a wedge mechanism. By contrast with the depiction, the ramps 7 can also have a ramp angle that changes over their length; in particular, the slope can decrease as the friction brake lining 5 is moved farther, i.e. an angle between the ramps 7 and the friction surface 8 of the brake disc 3 becomes increasingly acute. As a result, a rapid advancing of the friction brake lining 5 in relation to the brake disc 3 is achieved at the beginning of the movement, and a powerful self-amplification of the disc brake 1 that has not yet been explained in detail is achieved at the end of the movement, i.e. with a powerful compressive and braking force.

In order to actuate the disc brake 1, the movable friction brake lining 5 is moved on its helical path along the ramps 7. In the course of this, it moves in the circumference direction of the brake disc 3 and at the same time, toward the brake disc 3 until it comes into contact with its friction surface 8, is pressed against the brake disc 3, and brakes the brake disc 3. As has already been described, the brake caliper 2 here is shifted perpendicular to the brake disc 3 and presses the fixed friction brake lining 4 against the other side of the brake disc 3. The rotating brake disc 3 exerts a friction force in the circumference direction of the brake disc 3 on the movable friction brake lining 5 that is pressed against it for the braking. In the rotation direction of the brake disc 3 indicated by arrow 10, the friction force exerted by the brake disc 3 acts on the friction brake lining 5 in the direction of a narrowing gap between the ramps 7 and the brake disc 3. Due to the progression of the ramps 7 that is inclined at an angle to the friction surface 8 of the brake disc 3, the support of the movable friction brake lining 5 against the ramps 7 produces a supporting force perpendicular to the ramps 7. The supporting force has a component, which is perpendicular to the friction surface 8 of the brake disc 3 and presses the friction brake lining 5 against the brake disc 3 in addition to a compressive force exerted by an actuating device that will be described in greater detail below. The braking force is thus amplified. The ramps 7 constitute a ramp mechanism or are part of a ramp mechanism or self-amplifying device that converts the friction force, which the rotating brake disc 3 exerts on the movable friction brake lining 5 that is pressed against it during braking, into a compressive force that presses the friction brake lining 5 against the brake disc 3 in addition to the compressive force exerted by the actuating device, thus increasing the braking force of the disc brake 1. The disc brake 1 has a self-amplification.

The disc brake 1 is electromechanical, i.e. it has an electrochemical actuating device 11. The actuating device 11 includes an electric motor 12 with a flange-mounted reduction gear 13 and a rack-and-pinion mechanism 14 equipped with a pinion 15 and a straight rack 16. One end of the rack 16 has an eye 17 that encloses a hinge pin 18, which is inserted into a forked hinge bracket 19 on the back side of the movable friction brake lining 5. The eye 17 and the hinge pin 18 form a hinge that connects the rack 16 to the movable friction brake lining 5 in articulating fashion. An inner surface of the eye 17 is crowned in order to permit the rack 16 to pivot in relation to the pin 18. In addition, the eye 17 has play in the lateral direction, i.e. in the axial direction of the hinge pin 18 in the hinge bracket 19. The electromechanical actuating device 11 moves the friction brake lining 5 on the helical path toward the brake disc 3 in the manner described above in order to actuate the disc brake 1. The eye 17 of the rack 16, the hinge bracket 19 of the movable friction brake lining 5, and the pin 18 combine to form a hinge 20 that attaches the rack 16 to the movable friction brake lining 5 in articulating fashion.

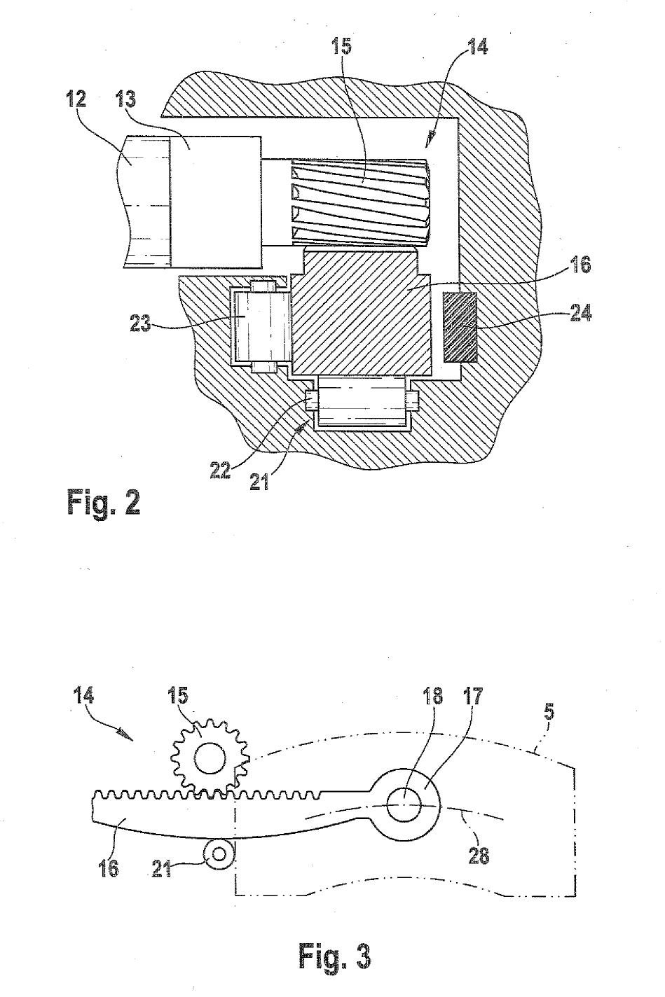

Spaced radially apart from the pinion 15, the rack-and-pinion mechanism 14 has an abutting support 21 and the rack 16 is situated between this abutting support 21 and the pinion 15. The abutting support 21 keeps the rack 16 engaged with the pinion 15. The abutting support 21 is stationary in relation to the pinion 15. The abutting support 21 can be a slide bearing; in the embodiment of the invention shown in the drawing, the abutting support 21 is a roller bearing and has a roller 22 supported in rotating fashion (FIG. 2).

Since the friction brake lining 5 moves on a helical path, the hinge 20 that connects the end of the rack 16 to the friction brake lining 5 also moves on a helical path. Consequently, the rack 16 does not move in a straight line, but also pivots around an imaginary rotation axis of the pinion 15 or an imaginary axis parallel to this that extends through the pinion 16. This pivoting movement of the rack 16 is compensated for by means of play that is provided in a gearing of the rack-and-pinion mechanism 14. The fact that a pivot angle of the rack 16 is small allows it to be compensated for by means of the play in the gearing of the rack-and-pinion mechanism 14. The rack 16 that meshes with the pinion 15 is shown in a side view in FIG. 3. As has been stated several times already, its eye 17 moves on a helical path that in the side view, has the appearance of an arc and is depicted with a dot-and-dash line 28. In FIG. 3, a double-dot-and-dash line depicts the movable friction brake lining 5, which is situated above the plane of the drawing. The rack 16, viewed from the side, engages the friction brake lining 5 at the level of a centroid of the friction brake lining 5; at one point of the movement path of the friction brake lining 5, the rack 16 is oriented tangential to the movement path. In the movement direction before and after this point, due to the movement of its eye 17 on the helical path 28, the rack 16 pivots by a slight angle around the rotation axis of the pinion 15. This pivoting motion of the rack 16 is compensated for by the play in the gearing of the rack-and-pinion mechanism 14.

As is clear from FIG. 3, an underside of the rack 16 oriented away from the pinion 15 is convex, i.e. a thickness of the rack 16 changes over its length. The convexity of the rack 16 is depicted in a very exaggerated fashion in order to make it visible. The changing thickness of the rack 16 causes the play in the gearing and therefore the possible pivot angle of the rack 16, to also change. Due to the convexity of the underside, the rack 16 is at its thickest and the play in the gearing is at its smallest in the longitudinal middle. If the rack 16 is situated with its longitudinal middle engaging the pinion 15, then the rack 16 extends tangential to the pinion 15. If the rack 16 is moved through rotation of the pinion 15, then it pivots around an imaginary axis parallel to the rotation axis of the pinion 15 in the manner described above. As the rack 16 is moved, the play in the gearing increases due to the decreasing thickness of the rack 16 toward the ends of the rack 16, thus enabling the pivoting motion. The underside of the rack 16 does not absolutely have to be convex; the thickness of the rack 16 over its length—and therefore the play in the gearing—depends on the geometry. The underside of the rack 16 must be shaped so as to provide the play required for the helical movement of its eye 17. This consideration applies to the surface of the rack 16 that is supported by the abutting support 21. This surface does not absolutely have to be the underside of the rack 16.

In the region of the pinion 15, possibly also offset in longitudinal direction of the rack 16, the rack 16 is guided with laterally oriented longitudinal guides 23, 24. The one longitudinal guide 23 has a roller bearing and the other longitudinal guide 24 is embodied in the form of a slide bearing. The rack 16 and the pinion 15 have a helical gearing that acts on the rack 16 in the direction toward the longitudinal guide 23 equipped with the roller bearing when the disc brake 1 is actuated. The rack 16 also has a play between the longitudinal guides 23, 24 in order to permit a pivoting motion around an imaginary axis extending radially through the rotation axis of the pinion 15 in a mid-length plane of the rack 16. It is thus possible to compensate for the helical movement of the eye 17 of the rack 16 during the movement of the movable friction brake lining 5. Since the movement on the helical path does not occur in a plane, but rather on a helix as explained above, the hinge 20 that connects the rack 16 to the friction brake lining 5 also moves laterally in relation to the rack 16. A further compensation in the lateral direction is assured through the lateral play of the eye 17 of the rack 16 in the hinge bracket 19.

In order to improve the pivoting capacity of the rack 16 in the lateral direction, the gearing of the pinion 15 and/or the rack 16 is crowned, i.e. the tooth flanks are convexly curved from one side of the rack 16 and/or pinion 15 to the other. In any case, this applies to the tooth flanks that provide support during actuation of the disc brake 1. It is sufficient if the gearing of either the rack 16 or the pinion 15 is crowned.

A free space between a housing 25 of the actuating device 11 and the hinge bracket 19 or the back side of the friction brake lining 5 is enclosed with a bellows 26. The rack-and-pinion mechanism 14 is thus hermetically sealed and protected from dirt and moisture.

A return spring 27 acts on the movable friction brake lining 5 in the direction toward the ramps 7 and in the direction of its starting position when the disc brake 1 is not actuated. The restoring spring 27 produces a contact between the leading flanks of the teeth of the gearing of the rack-and-pinion mechanism 14 and the reduction gear 13 during the release of the disc brake 1 as well; the same tooth flanks provide support during the releasing of the disc brake 1 as during the actuation.

1-9. (canceled)

10. A self-amplifying electromechanical friction brake, comprising:
a friction brake lining, which is movably guided in a circumference direction in relation to a braking body and at an angle to a friction surface of the braking body;
an electromechanical actuating device that is able to move the friction brake lining, the actuating device having a rack-and-pinion mechanism with a rotatably drivable pinion and a rack, which is driven by the pinion and which is connected to the friction brake lining;
an abutting support for the rack, which support is situated spaced radially apart from the pinion of the rack-and-pinion mechanism, with the rack being situated in an intermediate space between the pinion and the abutting support and with the abutting support keeping the rack engaged with the pinion; and
a gearing of the rack-and-pinion mechanism having play so that the rack is able to pivot around an imaginary rotation axis of the pinion and/or around an imaginary axis extending radially in relation to a rotation axis of the pinion, wherein the rack is connected to the friction brake lining in articulating fashion, forming an articulated connection.

11. The friction brake as recited in claim 10, wherein the rack-and-pinion mechanism has a crowned gearing.

12. The friction brake as recited in claim 10, wherein the rack-and-pinion mechanism has a lateral guide for the rack, which guide is situated near the pinion and guides the rack in a lateral direction in relation to the pinion.

13. The friction brake as recited in claim 10, wherein the rack-and-pinion mechanism has a helical gearing.

14. The friction brake as recited in claim 10, wherein a thickness of the rack and therefore a play in a gearing of the rack-and-pinion mechanism changes over a length of the rack.

15. The friction brake as recited in claim 10, wherein the friction brake lining is movably guided on a helical path coaxial to the braking body.

16. The friction brake as recited in claim 10, wherein the articulated connection of the rack to the friction brake lining has an eye equipped with a crowned inside surface.

17. The friction brake as recited in claim 10, wherein there is play lateral to the rack in the articulated connection of the rack to the friction brake lining.

18. The friction brake as recited in claim 10, wherein the rack is situated in the movement direction of the friction brake lining and/or at the level of a friction surface centroid of the friction brake lining.
